(19) United States
(12) Patent Application Publication
(10) Pub. No.: US 2019/0096592 A1
(43) Pub. Date: Mar. 28, 2019

(54) COMPOSITE MATERIAL AND ELECTRODE APPLIED WITH COMPOSITE MATERIAL AND METHODS OF MANUFACTURING THE SAME

(71) Applicant: INDUSTRIAL TECHNOLOGY RESEARCH INSTITUTE, Hsinchu (TW)

(72) Inventors: Li-Ching CHUNG, Zhubei City (TW); Po-I LIU, Kaohsiung City (TW); Chih-Hsiang FANG, Puzi City (TW); Tzu-Yu CHENG, Hsinchu City (TW); Hsin SHAO, Zhubei City (TW); Min-Chao CHANG, Hsinchu City (TW); Ren-Yang HORNG, Hsinchu City (TW); Teh-Ming LIANG, Tainan City (TW); Nyan-Hwa TAI, Hsinchu City (TW); Yi-Ting LAI, Taipei City (TW)

(73) Assignee: INDUSTRIAL TECHNOLOGY RESEARCH INSTITUTE, Hsinchu (TW)

(21) Appl. No.: 15/852,856

(22) Filed: Dec. 22, 2017

Related U.S. Application Data
(60) Provisional application No. 62/563,103, filed on Sep. 26, 2017.

(51) Int. Cl. H01G 11/34; C02F 1/469; H01G 11/86

(52) U.S. Cl. CPC H01G 11/34; C02F 2201/46; H01G 11/86; C02F 1/4691

(57) ABSTRACT

A method of manufacturing a composite material is provided. First, graphene oxide and activated carbon are provided individually. Graphene oxide and activated carbon are added into an alcohol to form a mixture. Then, the mixture is heated by microwave in a single step, so that graphene oxide is chemically reduced to form graphene at the active sites of the surface of the activated carbon uniformly, thereby forming a composite material. The embodied composite material is suitable for being the electrodes of the capacitive deionization (CDI) and supercapacitor application.

This application claims the benefit of U.S. provisional application Ser. No. 62/563,103, filed Sep. 26, 2017, the disclosure of which is incorporated by reference herein in its entirety.

### TECHNICAL FIELD

The disclosure relates in general to a composite material, a manufacturing method and applications of the same, and more particularly to a graphene/activated carbon composite material, the manufacturing method and applications of the same.

### BACKGROUND

The key material for the applications of capacitive deionization (CDI) and supercapacitor is carbonaceous material, requiring properties of high porosity, high specific surface area and high conductivity. Activated carbon is widely used because of its reasonable cost, scalable manufacturing and favorable stability. Also, activated carbon possesses advantages of high specific surface area and high desalination capacity. Many researches have been provided for the modification of activated carbon with high specific surface area, so as to increase specific capacitance and desalination capacity of the electrodes manufactured with the modified activated carbon. However, due to the poor conductivity of activated carbon, it is required to add an extra conductive material (e.g. graphite) during manufacturing the electrode. Graphite only assists in enhancing the electrode conductivity instead of ion adsorption capacity. Also, adding extra conductive material decreases the ratio of activated carbon to the electrode materials, which affects the effective sites of ion adsorption and electrode performance. Thus, it is one of important goals to develop an activated carbon composite material with high conductivity.

It is known that graphene has excellent properties, such as great heat dissipation due to its superior heat transfer coefficient (5300 W/m·K), high conductivity due to its high electron mobility (200,000 cm²/V·s), high transmittance and excellent mechanical properties, so that graphene is regarded as a material having great potential for modification of activated carbon. However, the conventional method for preparing graphene oxide usually takes couple days, which is quite time-consuming. Also, the chemical reducing agent used in the conventional step for reducing graphene oxide is toxic, environment-unfriendly. Extra steps and cost are required to deal with the chemical reducing agent, so as to restrict the applications of graphene. Moreover, in the conventional method for preparing graphene, staking of the graphene layers occurs easily, which has considerable effect on the electrode performance.

Thus, it is important for the researchers to develop a graphene-modified activated carbon composite material with high efficiency in low production cost; also, the composite material can be prepared rapidly, and the carbonaceous layers of the composite material are not stacked to each other easily, in order to form a composite material with high conductivity.

### SUMMARY

The disclosure is directed to a composite material, a manufacturing method and applications of the same. According to the embodiment, graphene oxide is chemically reduced rapidly by a single step of microwave heating for uniformly forming graphene at the surface of activated carbon, thereby forming a composite material having high conductivity and high specific capacitance. The composite material of the embodiment is suitable for manufacturing an electrode material in the applications of capacitive deionization (CDI) and supercapacitor.

According to one embodiment, a method of manufacturing a composite material is provided. The method includes providing a graphene oxide and an activated carbon; adding and uniformly dispersing the graphene oxide and the activated carbon in an alcohol to form a mixture; and performing a single step of microwave heating to the mixture, to uniformly and chemically reduce the graphene oxide to graphene at active sites of a surface of the activated carbon, thereby forming the composite material.

According to one embodiment, a composite material manufactured by the aforementioned method is provided.

According to another embodiment, an electrode is provided, comprising a conductive base, and a material mixture coated on the conductive base, wherein the material mixture at least includes a composite material manufactured by the aforementioned method, and at least one adhesive.

According to an alternative embodiment, a method of manufacturing an electrode is provided. The method includes: providing a conductive base; mixing an adhesive and the composite material manufactured by the aforementioned method, and then dispersed with a solvent and stirred uniformly to form a slurry; coating the slurry on the conductive base, followed by drying the slurry, so as to form a composite carbon electrode.

### BRIEF DESCRIPTION OF THE DRAWINGS

FIG. 1 is a flow illustrating a method of manufacturing a composite material according to one embodiment of the disclosure.

FIG. 2 is a flow illustrating a method of manufacturing an electrode according to one embodiment.

FIG. 3A and FIG. 3B respectively show the reaction temperature profiles and XRD (X-ray diffraction) data of a graphene oxide (GO) and a graphene chemically reduced from GO using an embodied method heated by microwave with different microwave powers (400 W, 800 W and 1200 W).

FIG. 4 shows SEM (scanning electron microscope) images of activated carbon, graphite and graphene.

FIG. 5 shows SEM images of the morphology of different carbon composite electrodes.

FIG. 6 is XRD plots of graphene oxide (GO) and graphene obtained from different thermal reductions.

FIG. 7 depicts cyclic voltammograms of carbon composite electrodes prepared with different amounts of graphene oxide, for conducting electrochemical analysis of the embodiment (in 0.5 M NaCl electrolyte, and scanned with a scan rate of 0.01 V/s).

FIG. 8 is electrochemical impedance spectra of carbon composite electrodes respectively containing unreduced graphene oxide and graphene chemically reduced by different thermal reduction processes.

FIG. 9 depicts cyclic voltammograms of carbon composite electrodes prepared with different amounts of graphene oxide, for conducting electrochemical analysis of the embodiment (in 0.5 M NaCl electrolyte, and scanned with a scan rate of 0.01 V/s).

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

According to the embodiment, a composite material, a method of manufacturing the composite material, an electrode containing the composite material and a method of manufacturing the electrode are provided. According to the embodiment, a composite material, comprising graphene oxide and activated carbon, can be rapidly prepared. The embodiment uses a single step of microwave heating to reduce graphene oxide for uniformly forming graphene at the surface of activated carbon. The reduction can be performed at low temperature and under atmosphere pressure, and the reduction rate can be increased greatly (e.g. dozens of hours required in the conventional preparation such as 48 hours chemically reduced to couple minutes such as 3 minutes only). Also, the non-toxic alcohols can be selected as a reducing agent (replacing the toxic reducing agent such as hydrazine in the conventional method) to reduce graphene oxide. Additionally, according to the embodiment, graphene oxide can be chemically reduced to form graphene on the surface of the activated carbon uniformly, so that the issue of agglomeration and re-stacking of hydrophobic graphene can be solved. Compared to the conventional processes, a graphene/activated carbon composite material prepared by the embodied method possesses significantly high conductivity and high specific capacitance. Therefore, the composite material and the method of manufacturing the composite material as provided in the embodiment have several advantages, such as the embodied manufacturing method includes non-toxic and easy-to-conduct (e.g. a single step of microwave heating at low temperature and atmosphere pressure) procedures, and the preparation time is greatly chemically reduced. Also, the embodied graphene/activated carbon composite material containing activated carbon and graphene has advantages of high specific surface area and high conductivity.

The embodiments of the disclosure can be widely used in different applications, particularly suitable for manufacturing an electrode material in the applications of capacitive deionization (CDI) and supercapacitor. For example, the embodied composite material and an adhesive can be adopted for preparing an electrode of a capacitive deionization (CDI) and a supercapacitor without adding any conductive material. The present disclosure is not limited to those applications mentioned herein. The embodiments are described in details with reference to the accompanying drawings. It is noted that the details of the descriptions such as manufacturing steps, material application and structural details of the embodiments are provided for exemplification, and the described details of the embodiments are not intended to limit the present disclosure.

It is noted that not all embodiments of the invention are shown. Modifications and variations of the embodied structures and manufacturing steps can be made without departing from the spirit of the disclosure to meet the requirements of the practical applications. Thus, there may be other embodiments of the present disclosure which are not specifically illustrated. Further, the experiments and results thereof are provided as illustrating some of exemplifications for clearly depicting the properties of the composite material manufactured by the embodied method, and shall not be construed as limitations to the present disclosure. Thus, the specification and the drawings are to be regard as an illustrative sense rather than a restrictive sense. Also, the identical and/or similar elements of the embodiments are designated with the same and/or similar reference numerals.

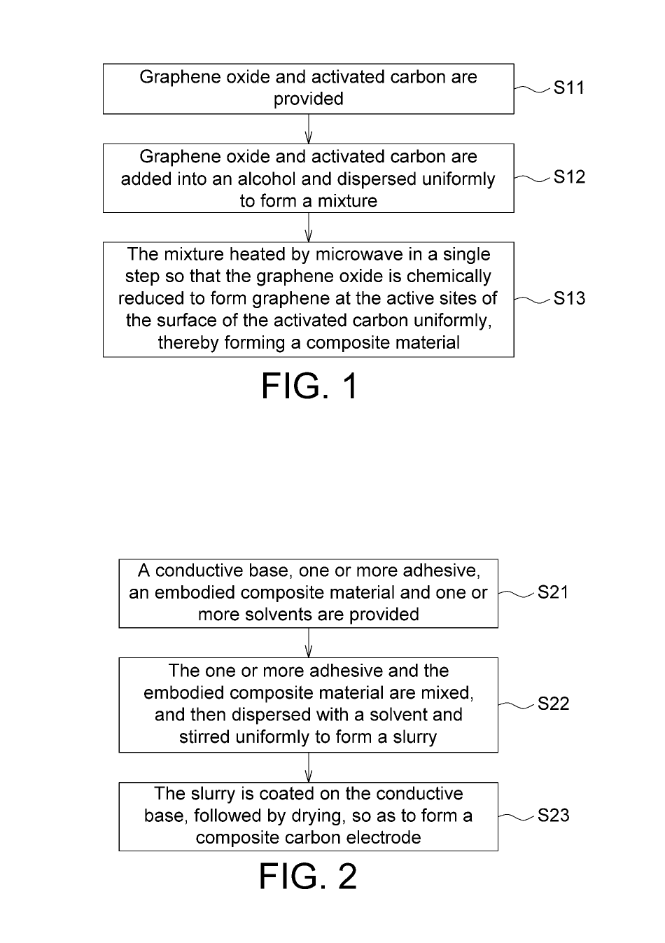

FIG. 1 is a flow illustrating a method of manufacturing a composite material according to one embodiment of the disclosure. As shown in step S11 of FIG. 1, graphene oxide and activated carbon are provided individually. Then, as shown in step S12, the graphene oxide and the activated carbon are added into an alcohol and dispersed uniformly to form a mixture. As shown in step S13, the mixture heated by microwave in a single step so that the graphene oxide is chemically reduced to form graphene at the active sites of the surface of the activated carbon uniformly, thereby forming a composite material. According to the embodiment, the alcohol is a reducing agent for reducing the graphene oxide and forming graphene on the surface of the activated carbon.

For manufacturing a graphene/activated carbon composite material of one embodiment, the amounts of the graphene oxide, the activated carbon and the alcohol as mixed are provided in a certain range, and the mixture is then one step-heated with microwave. In one example, an amount of weight of the graphene oxide to an amount of weight of the activated carbon added into the alcohol is in a range of 0.05 to 0.5 (that is, the graphene oxide and the activated carbon added into the alcohol have a weight ratio of 0.05 to 0.5). In another example, an amount of weight of the graphene oxide to an amount of weight of the activated carbon added into the alcohol is in a range of 0.1 to 0.25 (that is, the graphene oxide and the activated carbon added in the alcohol have a weight ratio of 0.1 to 0.25). If the weight ratio of the graphene oxide to the activated carbon is too low, the conductivity of the composite material would not be increased effectively. If the weight ratio of the graphene oxide to the activated carbon is too high, graphene tends to aggregate thereby decreasing the specific surface area of the composite material. Both situations (i.e. low or high weight ratio) lead to the graphene/activated carbon composite material having lower specific capacitance.

Additionally, different kinds of the activated carbons can be applicable in the embodiment. The activated carbon prepared by chemical activation, physical activation, physical-chemical activation and chemical-physical activation can be adopted in the embodiment. In one example, the activated carbon is (but not limited to) ACP (i.e. produced from petroleum coke) or ACW (i.e. produced from wood charcoal, available from ECHO CHEMICAL CO., LTD.). Also, in one embodiment, before adding into the alcohol, the activated carbon has (but not limited to) a specific surface area in a range of 500 m²/g and 3000 m²/g, and has (but not limited to) the pore size in a range of 1 nm to 1000 nm.

It is noted that another material mixed with the activated carbon for forming a mixture to be microwave-heated of the embodiment is graphene oxide, not graphene. Also, there is no particular limitation for preparing the graphene oxide. The graphene oxide can be prepared by the Brodie, Staudenmaier, and Hummers methods.

Moreover, an amount of weight of the alcohol (which is used for dispersing the graphene oxide and also functions as a reducing agent) to an amount of weight of the graphene oxide added in the alcohol can be, but not limited to, a value in a range of 0.01 to 0.4. For example, in the experiment of 80 mg of graphene oxide dispersed in 30 ml of ethylene glycol, the weight ratio of adding amounts is 0.4 (i.e. 30/80). In another example, the amount of weight of the alcohol to the amount of weight of the graphene oxide can be in a range of 0.01 to 0.2. It is, of course, that those numerical values described herein are provided for exemplification, not for limitation.

Additionally, in one embodiment, the alcohol as selected may have a chain length of 2 to 4 carbon atoms (i.e. have carbon chain lengths between C2 and C4). In one example, the alcohol can be (but not limited to) ethylene glycol as a reducing agent, so that the graphene oxide is chemically reduced to graphene uniformly formed and distributed at the active sites of the surface of the activated carbon. The larger the number of carbon atoms, the lower the polarity of alcohol, which has considerable effects on the dispersion of the hydrophilic activated carbon and the result of microwave heating.

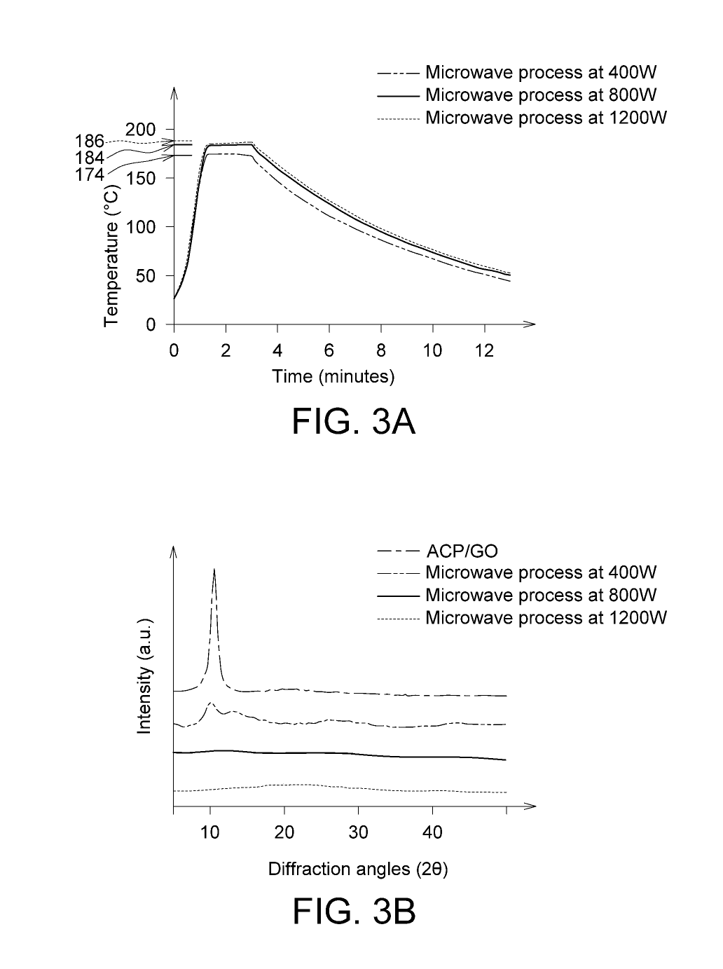

Moreover, in the single step (i.e. one-step) of microwave heating according to one embodiment, the mixture is heated with microwave for less than 30 minutes. For example, the mixture is heated with microwave for a period ranging from 3 minutes to less than 30 minutes. Also, in one embodiment, the mixture is heated with microwave at a temperature of 50° C. to 300° C., or at a temperature of 100° C. to 200° C. Also, in one embodiment, the mixture can be heated by microwave with a microwave power ranging from 400 W to 1600 W. If the microwave power is too low, the reduction of the graphene oxide would not be complete. If the microwave power is too high, the carbon structure would be damaged. In one example, the mixture can be heated by microwave with a microwave power ranging from 400 W to 1200 W. FIG. 3A and FIG. 3B respectively show the reaction temperature profiles and XRD (X-ray diffraction) data of a graphene oxide (GO) and a graphene chemically reduced from GO using an embodied method heated by microwave with different microwave powers (400 W, 800 W and 1200 W). As shown in FIG. 3B, when the microwave power is 400 W, the XRD data presents a peak position at 10.4 of the angle 2 theta (2θ), and this result indicates that the reduction of the graphene oxide is not complete. In one example, the microwave power can be (but not limited to) 800 W. Additionally, in one embodiment, the mixture is (but not limitedly) heated with microwave having a frequency in a range of 0.3 GHz to 300 GHz.

It is noted that those numerical values described in the embodiments are provided for exemplification, not for limiting the scope of the disclosure.

It is, of course, that the microwave heating condition can be adjusted and changed depending on the to-be-heated materials of the mixture (i.e. including adding amount and the ratio of each component of the mixture) in the practical application. For example, the microwave heating time is determined in relation to other parameters (such as microwave temperature, power, frequency, etc.) for rapidly reducing the graphene oxide and forming graphene at the surface of the activated carbon. In one example, a mixture containing 80 ml of graphene oxide, 0.4 g of activated carbon and 30 ml of ethylene glycol can be microwave heated with a power of 800 W for 3 minutes for rapidly reducing the graphene oxide at the surface of the activated carbon.

According to the embodied method, a single step of microwave heating (e.g. localized heating at high temperature) is performed at a low temperature and atmosphere pressure on a mixture containing graphene oxide and activated carbon with high specific surface area, so that the graphene oxide can be chemically reduced by a non-toxic reducing agent (such as ethylene glycol) to uniformly form graphene at the active sites of the surface of activated carbon, thereby rapidly forming a composite material. Compared to the conventional manufacturing method, the embodied method significantly decreases the time for manufacturing a graphene/activated carbon composite material (e.g. from dozens of hours decreased to couple minutes). According to the embodiment, a composite material (also referred as a graphene/activated carbon composite material) obtained by an embodied method includes activated carbon as described above and graphene uniformly form (by reduction) at the active sites of the surface of the activated carbon. Additionally, the composite material manufactured by an embodied method does solve the issue of poor-distribution of graphene prepared by a conventional mixing method, and also effectively prevent from re-stacking of the graphene layers due π-π attractive force between the benzene rings.

Also, the experimental results have also improved that a composite material as manufactured by an embodied method does have high conductivity and high specific capacitance. Accordingly, the composite material of the embodiment is suitable for being adopted to manufacture a carbon composite electrode in the applications of capacitive deionization (CDI) and supercapacitor. The carbon composite electrode of the embodiment has excellent properties of an electrode because of the graphene as chemically reduced uniformly formed at the active sites of the surface of the activated carbon. According to the embodiment, an electrode, containing an embodied graphene/activated carbon composite material having high conductivity and high specific capacitance, can be prepared without adding any conductive material, and the weight ratio of activated carbon of the composite material also increases so as to improve the adsorption capability of the carbon electrode. Thus, according to the method of the embodiment, a graphene/activated carbon composite material of the embodiment and an electrode containing an embodied composite material can be prepared and manufactured easily and rapidly. The low-cost and high efficient graphene/activated carbon composite material of the embodiment is suitable for being applied in the mass production.

A method for manufacturing an electrode according to one of the applications is provided herein. However, this method is provided for exemplification, not for limiting the applications and the details of the disclosure. FIG. 2 is a flow illustrating a method of manufacturing an electrode according to one embodiment. As shown in FIG. 2, a conductive base, one or more adhesive, an embodied composite material and one or more solvents are provided (step S21). The one or more adhesive and the embodied composite material are mixed, and then dispersed with a solvent and stirred uniformly to form a slurry (step S22). The slurry is coated on the conductive base, followed by drying (e.g. in an oven), so as to form a composite carbon electrode (step S23).

Accordingly, a carbon composite electrode as manufactured by an embodied method includes a conductive base, and a material mixture coated on the conductive base, wherein the material mixture at least includes the composite material of the embodiment and at least one adhesive.

In one embodiment, a slurry coated on a conductive base is dried (e.g. in an oven) at (but not limited to) a temperature of 70° C. to 140° C., so as to form a composite carbon electrode. In one embodiment, a weight ratio of the composite material of the embodiment to the adhesive is in a range from 7:3 to 9:1; however, the disclosure is not limited thereto. Also, the solvent used in the embodiment can be a single solvent or a mix of two or more solvents; the disclosure has no particular limitation to the numbers of the compounds in the solvent of the embodiment. In one example, the solvent includes N-methyl-2-pyrrolidone (NMP), or dimethylacetamide (DMAc), or a combination thereof.

Some of related experiments are provided below for illustration, including preparation of a composite material of the embodiment, properties of the composite material (e.g. determined by SEM images and structural analysis of graphene), preparation of an electrode containing the embodied composite material, properties of the electrode (e.g. obtaining specific capacitance by electrochemical analysis, and proceeding capacitive deionization (CDI) experiments). It is, of course, that the experimental contents and the results of measurements below are provided for exemplification, not for limiting the composite material of the embodiment and the applications using the embodied composite material.

<Preparation of Graphene/Activated Carbon Composite Material by Microwave Heating>

The embodiment provides a method for manufacturing a graphene/activated carbon composite material using one-step microwave heating, and the composite material can be used to manufacture an electrode in the applications of capacitive deionization (CDI) and supercapacitor. The composite material can be prepared by a method provided below.

First, graphene oxide was prepared by the Hummers method. Then, 80 mg of graphene oxide and 0.4 g of activated carbon (i.e. the weight ratio of graphene oxide: activated carbon is 1:5) were mixed and added into 30 ml of ethylene glycol (i.e. a reducing agent). The activated carbon can be ACP (i.e. produced from petroleum coke) or ACW (i.e. produced from wood charcoal, available from ECHO CHEMICAL CO., LTD). The mixture was heated (irradiated) by microwave with a microwave power of 800 W for 3 minutes under a reflow condition. After the reaction was completed and the production is cooled to room temperature, ethanol was added for centrifugation at 5000 rpm for 20 minutes and the centrifugation step was repeated 3 times to wash the residual of ethylene glycol solvent. After dried, a graphene/activated carbon composite material can be obtained.

<SEM Images of Graphene/Activated Carbon Composite Material>

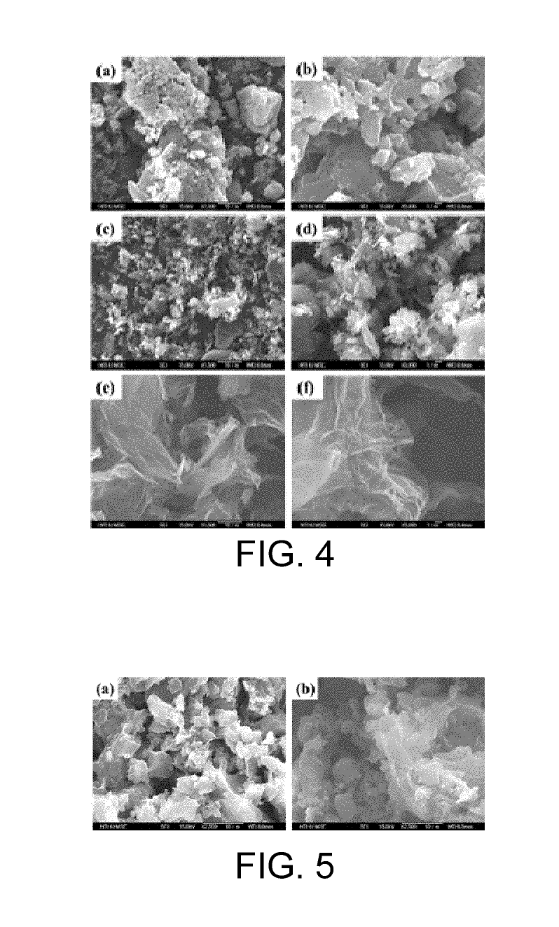

FIG. 4 shows SEM (scanning electron microscope) images of activated carbon, graphite and graphene. The images (a) and (b) are SEM images of activated carbon, the images (c) and (d) are SEM images of graphite, and the images (e) and (f) are SEM images of graphene. The results of the images (e) and (f) as shown in FIG. 4 have indicated that the flaky graphene shows more folds, and it means that the specific surface area of graphene is higher than the specific surface area of other carbonaceous materials (e.g. activated carbon and graphite).

FIG. 5 shows SEM images of the morphology of different carbon composite electrodes. The SEM images of FIG. 5 are obtained by analyzing the carbon composite electrodes manufactured by different reduction processes, wherein the image (a) is a SEM image of a composite material of activated carbon mixed with graphene prepared from thermal reduction (i.e. prepared by a conventional manufacturing method), and the image (b) is a SEM image of a graphene/activated carbon composite material manufactured by microwave reduction of the embodiment. The image (a) of FIG. 5 has indicated that the composite material prepared by a conventional manufacturing method, which reduces graphene oxide first and then mixes graphene with activated carbon, would cause agglomeration of graphene and lead to re-stacking of the graphene layers, thereby affecting the distribution of graphene on the activated carbon and the surface area of the composite material. However, the image (b) of FIG. 5 has proven that the microwave reduction of the embodiment is a single thermal step of rapid reduction, which reduce graphene oxide directly and rapidly for uniformly forming graphene on the surface of the activated carbon, thereby preventing agglomeration of graphene and re-stacking of the graphene layers.

<Graphene Structure Analyzed from X-Ray Diffraction Data>

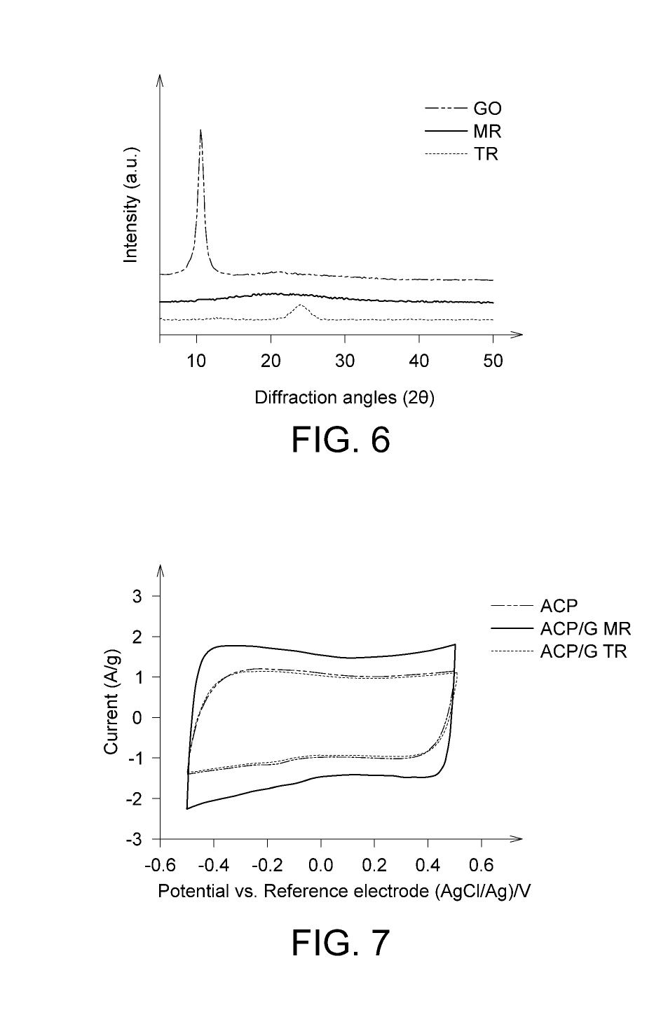

FIG. 6 is XRD plots of graphene oxide (GO) and graphene obtained from different thermal reductions. In this experiment, graphene oxide, graphene formed by conventional thermal reduction, and graphene formed by microwave reduction according to the embodiment are analyzed by an X-ray diffractometer (XRD). In FIG. 6, the curve GO represents unreduced graphene oxide, the curve TR represents graphene formed by conventional thermal reduction, and the curve MR represents graphene formed by microwave reduction (i.e. microwave irradiation) according to the embodiment. The XRD pattern is a x-y plot of the intensity (in the y-axis) of X-rays scattered at different diffraction angles 2 theta (2θ) (in the x-axis) by a sample.

Compared to the curve GO which represents unreduced graphene oxide, the peak detected at the position of the angle (2θ) of 10.4° has not been observed in the curve MR represents graphene formed by microwave reduction in 3 minutes (i.e. the peak of the curve GO almost disappears in the curve MR). Therefore, after the oxide-containing functional groups between the graphene layers are removed, the distances between the graphene layers can be decreased. The curve TR which represents graphene formed by conventional thermal reduction has shown a wide signal detected at the position of the angle (2θ) of 24.5°, and it indicates the re-stacking phenomenon of the graphene layers. Accordingly, no diffraction peak has been observed from the XRD data (i.e. the curve MR) of the graphene formed by microwave reduction of the embodiment.

<Electrode Manufacture and Capacitance Measurement>

In one example of manufacturing an electrode, the embodied graphene/activated carbon composite material and an adhesive of polyvinylidene difluoride (PVDF) are mixed by a weight ratio of 9:1, followed by adding a solvent of N-methyl-2-pyrrolidone (NMP) to form a mixture, and the mixture is stirred for 24 hours to form a slurry. Then, the slurry is evenly coated on a titanium foil having 50 μm thick, and dried in an oven of 140° C. for 4 hours to complete a composite carbon electrode of an embodiment.

Afterwards, several electrochemical analyses can be conducted on the composite carbon electrode as prepared.

<Electrochemical Analysis of Carbon Composite Electrode>

1. Capacitance Measurement of Electrode

Capacitance measurement of an electrode was conducted by a cyclic voltammetry (CV) method. A three electrode system includes 0.5 M NaCl solution (electrolyte), the working electrode consisted of an area of 1 cm×1 cm, a platinum (Pt) wire as counter electrode, and Ag/AgCl as reference electrode. Cyclic voltammetry (CV) was performed to determine the capacitance with the scan range of −0.5 V-0.5 V and the scan rate of 0.01 V/s. A gravimetric (or specific) capacitance can be obtained from the integration under the CV curve (Q) divided by working voltage potential range (V) and mass (g) of the electrode material.

FIG. 7 depicts cyclic voltammograms of carbon composite electrodes respectively containing unreduced graphene oxide and graphene chemically reduced by different thermal reduction processes (in 0.5 M NaCl electrolyte, and scanned with a scan rate of 0.01 V/s). Curve ACP represents a carbon composite electrode containing unreduced graphene oxide. Curve ACP/G TR (i.e. ACP/graphene thermal reduction) represents a carbon composite electrode containing a composite material formed by a conventional thermal reduction. Curve ACP/G MR (i.e. ACP/graphene microwave reduction) represents a carbon composite electrode containing a composite material formed by microwave reduction (i.e. microwave irradiation) of the embodiment.

The results of FIG. 7 show that the shapes of three CV curves (i.e. representing the electrodes containing unreduced graphene oxide or composite materials) are rectangular (e.g. without deformation), which indicated the electrodes have ideal electrical double layer capacitance (EDLC). Among three electrodes, the CV results show that the carbon composite electrode (graphene/activated carbon) containing a composite material formed by microwave reduction of the embodiment has higher capacitance. The highest specific capacitance of the electrode containing the composite material of the embodiment is up to 190.9 F/g, and an average specific capacitance thereof is 170.5 F/g. Compared to 100.4 F/g of an average specific capacitance measured from an ACP purely activated carbon electrode (using graphite as conductive material), the average specific capacitance of the electrode containing the composite material of the embodiment has increased about 70%. Accordingly, FIG. 7 has proven that the graphene/activated carbon composite material formed by microwave reduction of the embodiment has higher specific surface area and better characteristic of capacitance consequently.

2. Analysis of Electrochemical Impedance of Electrode

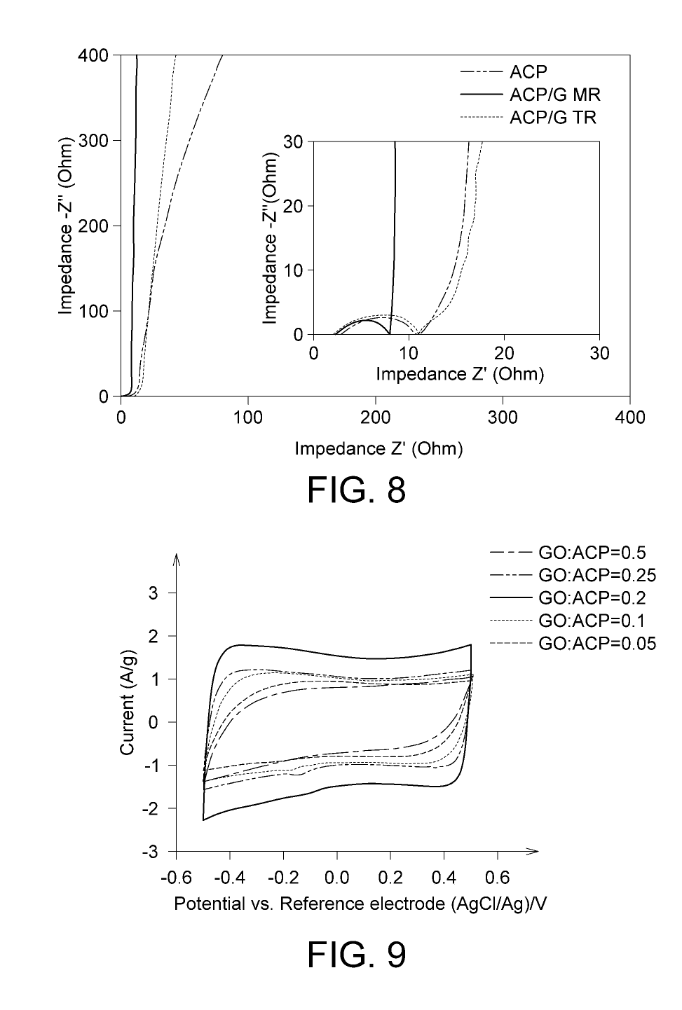

FIG. 8 is electrochemical impedance spectra of carbon composite electrodes respectively containing unreduced graphene oxide and graphene chemically reduced by different thermal reduction processes, which are used for analyzing the impedance generated from transmission and diffusion of electrons and ions in the electrochemical reaction. Curve ACP represents a carbon electrode containing purely activated carbon (using graphite as conductive material). Curve ACP/G TR (i.e. ACP/graphene thermal reduction) represents a carbon composite electrode containing a composite material formed by a conventional thermal reduction. Curve ACP/G MR (i.e. ACP/graphene microwave reduction) represents a carbon composite electrode containing a composite material formed by microwave reduction (i.e. microwave irradiation) of the embodiment.

The results of electrochemical impedance spectra (EIS) as shown in FIG. 8 reveal that the carbon composite electrode of the embodiment (containing a composite material formed by a single step of microwave reduction) has the smallest semicircle shape at high frequencies; that means the lowest internal resistance (i.e. the smaller the semicircle of EIS, the lower the internal resistance) within the electrode material. This is because the graphene oxide can be chemically reduced for uniformly forming graphene with high conductivity at the surface of the activated carbon, thereby facilitating electron transmission within the electrode material and decreasing the impedance. Also, the vertical lines are shown at low frequencies of EIS, and it indicates the ions can be diffused and adsorbed within the interior pores. The capacitance can be improved consequently.

According to the CV test for capacitance measurement and the electrochemical impedance test as described above, the graphene/activated carbon composite material prepared by reducing graphene oxide with microwave heating (i.e. microwave irradiation) of the embodiment does have higher specific surface area and lower electrochemical impedance, which leads to better capacitance performance. The value of the specific capacitance is very important in the CDI and supercapacitor application. The higher the specific capacitance, the better the electrochemical performance.

<Analysis of Carbon Composite Electrode Prepared with Different Amounts of Graphene Oxide>

FIG. 9 depicts cyclic voltammograms of carbon composite electrodes prepared with different amounts of graphene oxide, for conducting electrochemical analysis of the embodiment (in 0.5 M NaCl electrolyte, and scanned with a scan rate of 0.01 V/s). In this experiment, capacitance performances of the carbon composite electrodes prepared from different amounts of graphene oxide adding to activated carbon were analyzed, wherein the adding amounts of graphene oxide are 200 mg, 100 mg, 80 mg, 40 mg and 20 mg, respectively. That is, the weight ratio of graphene oxide (GO) to activated carbon (ACP) are 0.5, 0.25, 0.2, 0.1 and 0.05, respectively. Similarly, a composite material manufactured by a single step of microwave reduction as the method described above is obtained, and then applied for forming a carbon composite electrode, followed by conducting a CV test. The results as depicted in FIG. 9 show that the average specific capacitances are 90.3 F/g, 138.9 F/g, 170.5 F/g, 117.4 F/g and 96.2 F/g, respectively. Under the same weight amount ratio of GO: ACP, the specific capacitance of the embodied carbon composite electrode prepared with microwave heating is 38% higher than the specific capacitance of the carbon composite electrode prepared with conventional thermal process (i.e. increasing from 123.5 F/g to 170.5 F/g). Also, compared to the pure activated carbon (ACP) electrode, the embodied carbon composite electrodes prepared with the weight ratio of GO: ACP ranging from 0.1-0.25 have significantly improved specific capacitances. Some results of related experiments are listed in Table 1.

TABLE 1

| | Weight ratio of graphene | |
|---|---|---|
| | oxide (GO):activated | Average specific |
| Electrode Material | carbon (ACP) | capacitance (F/g) |
| Activated carbon (ACP) | 0 | 100.4 |
| electrode | | |
| Graphene/ACP composite | 0.2 | 123.5 |
| electrode prepared by | | |
| conventional thermal | | |
| reduction | | |
| Graphene/ACP composite | 0.05 | 96.2 |
| electrode prepared by | 0.1 | 117.4 |
| microwave reduction | 0.2 | 170.5 |
| | 0.25 | 138.9 |
| | 0.5 | 90.3 |

Additionally, the results of Raman spectra also indicated that too much graphene oxide as added would lead to the re-stacking of reducing graphene, so that the corresponding I to/IG ratio of Raman signal and the surface area of the carbon composite electrode decrease, thereby decreasing the specific capacitance. However, if graphene oxide with insufficient amount is mixed with activated carbon, the graphene after reduction would not form an effective conductive network between the carbonaceous materials, resulting in the poor capacitance performance of the composite material. According to the example above (i.e. 100 mg, 80 mg and 40 mg of graphene oxide; the weight ratios of graphene oxide: activated carbon are 0.25, 0.2 and 0.1, respectively), the composite material prepared from 80 mg (i.e. 0.2 weight ratio) of graphene oxide as added has better average specific capacitance 170.5 F/g than the other composite materials prepared from 0.25 and 0.1 weight ratios of graphene oxide. In the applications, it is suggested that the composite materials having better average specific capacitances are selected in favor of process optimization.

According to the results of FIG. 9, although different specific capacitances of the electrode containing composite materials with different weight ratios of graphene oxide to activated carbon are obtained, the disclosure is not limited to a specific value of weight ratio such as 0.2 of graphene oxide to activated carbon. In one embodiment, an amount of weight of the graphene oxide to an amount of weight of the activated carbon as added can be in a range of 0.05 to 0.5. Compared to other carbon composite electrodes prepared by the conventional processes, the electrodes containing composite material prepared by the embodied method have significantly increased specific capacitances.

<Capacitance Measurement and Comparison of Carbon Composite Electrode Prepared Using Different Activated Carbon Materials>

The experiments describe above use activated carbon ACP for preparing the composite material of the embodiment. In this experiment, different activated carbon such as ACW is also selected for manufacturing the composite material of the embodiment by a single step of microwave heating. The composite material as formed is further used for preparing a composite electrode, and the specific capacitance of the composite electrode is also measured and listed in Table 2. As shown in Table 2, manufacturing the electrodes by the conventional method and the embodied microwave heating method are conducted. According to the results, the specific capacitance of the carbon composite electrode of the embodiment is up to 68.6 F/g. Compared to 52.1 F/g of the specific capacitance of the carbon composite electrode prepared by a conventional method using conductive graphite, the specific capacitance of the carbon composite electrode of the embodiment has increased by 31.7%. This result has indicated that the method of the embodiment is suitable for modifying different carbonaceous materials, resulting in significantly increasing the specific capacitance of the carbon composite electrode.

TABLE 2

| | Specific | |
|---|---|---|
| Electrode Material | capacitance (F/g) | Note |
| ACW carbon electrode | 52.1 | — |
| Graphene/ACW | 68.6 | Containing composite |
| composite electrode | | material prepared by |
| | | microwave heating (for |
| | | reducing graphene oxide) |

<CDI Experiments of Graphene/Activated Carbon Composite Electrode>

In this experiment, measurements and comparison of the capacitive deionization (CDI) efficiencies of the pure carbon electrode (ACW and ACP) and the graphene-modified carbon composite electrode (containing the graphene/activated carbon composite material of the embodiment) are conducted, and the results are listed in Table 3. The CDI results in Table 3 have indicated that the desalination capacities of the ACW pure carbon electrode and the ACP pure carbon electrode are 5.4±0.9 mg/g and 10.3±0.6 mg/g, respectively. The different properties of activated carbons themselves lead to different desalination capacities. The specific surface area of the ACP carbonaceous material is higher than the specific surface area of the ACW carbonaceous material, so that the ACP carbonaceous material provides more sites for ion adsorption. Moreover, the graphene-modified carbon composite electrodes containing the embodied composite materials prepared by microwave heating have increased desalination capacities of 7.2±0.5 mg/g and 18.6±1.2 mg/g, which are 1.3 times and 1.8 times of the desalination capacities of the pure carbon electrodes, respectively. Accordingly, the carbonaceous material modified with graphene by the embodied method can increase the conductivity (without adding conductive material) and the surface area, thereby significantly improving the desalination capacity.

TABLE 3

| Electrode Material | Desalination Capacity (mg/g) |
|---|---|
| ACW pure carbon electrode | 5.4 ± 0.9 |
| ACP pure carbon electrode | 10.3 ± 0.6 |
| Graphene/ACW composite electrode | 7.2 ± 0.5 |
| Graphene/ACP composite electrode | 18.6 ± 1.2 |

According to the aforementioned description, a composite material and a method of manufacturing the same are provided, using a single step of microwave heating to reduce graphene oxide to uniformly form graphene at the surface of activated carbon. Compared to conventional thermal reduction method, the embodiment provides a method with several advantages; for example, the reduction can be performed at low temperature and under atmosphere pressure, and the reduction rate can be increased greatly (e.g. dozens of hours required in the conventional preparation (such as 48 hours) chemically reduced to couple minutes (such as 3 minutes only). Additionally, the non-toxic alcohols can be selected as a reducing agent (replacing the toxic reducing agent such as hydrazine in the conventional method) to reduce graphene oxide and uniformly form graphene on the surface of the activated carbon, thereby preventing the agglomeration and re-stacking of hydrophobic graphene. Therefore, compared to other known processes, a graphene/activated carbon composite material with high conductivity and high specific capacitance can be prepared by the method of the embodiment. Thus, the embodiment of the disclosure is particularly suitable for being applied for manufacturing the electrodes in the applications of capacitive deionization (CDI) and supercapacitor. When the graphene/activated carbon composite material of the embodiment is used for manufacturing an electrode, it is no need to add any extra conductive material, and the production cost of the electrode containing the composite material is greatly decreased. Therefore, the methods of the embodiment can rapidly and simply manufacture the embodied graphene/activated carbon composite material and the electrode applied with the same. In the applications of capacitive deionization (CDI) and supercapacitor, the embodied graphene/activated carbon composite material includes activated carbon with high specific surface area and graphene with high conductivity. The low-cost and high-efficiency graphene/activated carbon composite material of the embodiment is particularly suitable for being applied in mass production.

The procedures or experimental contents above are provided for describing some embodiments or applications of the disclosure. The disclosure is not limited to the numerical values, steps and applications described above. Also, the exemplified steps can be modified or changed, depending on the actual needs of the practical applications. Thus, the exemplified numerical values and experimental results are provided only for demonstration, not for limitation. It is known by people skilled in the art that the details of the manufacturing procedures/steps and structures could be adjusted according to the requirements of the practical applications.

It will be apparent to those skilled in the art that various modifications and variations can be made to the disclosed embodiments. It is intended that the specification and examples be considered as exemplary only, with a true scope of the disclosure being indicated by the following claims and their equivalents.

1. A method of manufacturing a composite material, comprising:
providing a graphene oxide and an activated carbon;
adding and uniformly dispersing the graphene oxide and the activated carbon in an alcohol to form a mixture; and
performing a single step of microwave heating to the mixture, to uniformly and chemically reduce the graphene oxide to graphene at active sites of a surface of the activated carbon, thereby forming the composite material.

2. The method of manufacturing the composite material according to claim 1, wherein the graphene oxide and the activated carbon added in the alcohol have a weight ratio of 0.05 to 0.5.

3. The method of manufacturing the composite material according to claim 1, wherein the graphene oxide and the activated carbon added in the alcohol have a weight ratio of 0.1 to 0.25.

4. The method of manufacturing the composite material according to claim 1, wherein the alcohol and the graphene oxide added in the alcohol have a weight ratio of 0.01 to 0.2.

5. The method of manufacturing the composite material according to claim 1, wherein the alcohol has a chain length of 2 to 4 carbon atoms.

6. The method of manufacturing the composite material according to claim 1, wherein the activated carbon has a specific surface area between 500 m²/g and 3000 m²/g before adding into the alcohol.

7. The method of manufacturing the composite material according to claim 1, wherein the activated carbon has a pore size between 1 rim to 1000 nm before adding into the alcohol.

8. The method of manufacturing the composite material according to claim 1, wherein the mixture is heated with microwave for less than 30 minutes.

9. The method of manufacturing the composite material according to claim 1, wherein the mixture is heated with microwave for 3 minutes to less than 30 minutes.

10. The method of manufacturing the composite material according to claim 1, wherein the mixture is heated with microwave at a temperature of 50° C. to 300° C.

11. The method of manufacturing the composite material according to claim 1, wherein the mixture is heated with microwave having a microwave power between 400 W to 1600 W.

12. The method of manufacturing the composite material according to claim 1, wherein the mixture is heated with microwave having a frequency between 0.3 GHz to 300 GHz.

13. A composite material, manufactured by using the method according to claim 1.

14. An electrode, comprising:
a conductive base; and
a material mixture, coated on the conductive base, wherein the material mixture at least comprises:
the composite material, manufactured by using the method according to claim 1; and
at least one adhesive.

15. A method of manufacturing an electrode, comprising:
providing a conductive base;
mixing an adhesive and the composite material manufactured by using the method according to claim 1, and then dispersed with a solvent and stirred uniformly to form a slurry;
coating the slurry on the conductive base, followed by drying the slurry, so as to form a composite carbon electrode.

16. The method of manufacturing the electrode according to claim 15, wherein a weight ratio of the composite material to the adhesive is in a range from 7:3 to 9:1.

17. The method of manufacturing the electrode according to claim 15, wherein the solvent comprises N-methyl-2-pyrrolidone (NMP), or dimethylacetamide (DMAc), or a combination thereof.
